(19) United States
(12) Patent Application Publication
(10) Pub. No.: US 2014/0338322 A1
(43) Pub. Date: Nov. 20, 2014

(54) POWER GENERATOR USING SEA WAVE ENERGY

(71) Applicant: Steel Eel Limited, London (GB)

(72) Inventor: Jonathan Francis Gordon Ingram, Hampshire (GB)

(73) Assignee: Steel Eel Limted, London (GB)

(21) Appl. No.: 14/356,866

(22) PCT Filed: Nov. 7, 2012
(86) PCT No.: PCT/GB2012/052769

§ 371 Date: May 7, 2014

(30) Foreign Application Priority Data
Nov. 7, 2011 (GB) 1119150.9

(51) Int. Cl. F03B 13/20

(52) U.S. Cl. CPC F03B 13/20
USPC 60/504

(57) ABSTRACT

A wave-power device comprising a rotatable elongate part comprising axle and a buoyant structure helically coiled around the axle and extending at least part of the length thereof, the rotatable elongate part being connected to a power generator, characterised in that the buoyant structure has a cross-sectional shape having a width greater than its height.

### CROSS-REFERENCE TO RELATED APPLICATIONS

This application is a 371 application of PCT/GB2012/052769 filed Nov. 7, 2012, which claims benefit of GB Application 1119150.9, filed Nov. 7, 2011. The present application claims priority to, and benefit of, this application/these applications, pursuant to 35 U. S. C. §119(e) and any other applicable statute or rule.

### FIELD OF THE INVENTION

This invention relates to a wave-power generator.

### BACKGROUND OF THE INVENTION

Large stretches of open water, for example seas and large lakes, experience.

To date, many wave-powered generators have been proposed, however, the majority of these devices are complex and are expensive to maintain. Additionally, they are fixed to a predetermined wavelength and so stall or fail where the wavelength varies. Additionally, they rely upon a continuous wave front and where there is a gap in the waves, the devices can stall or fail.

Additionally, the capture of CO2 to reduce the level of the gas in the atmosphere is becoming a pressing issue.

U.S. Pat. No. 3,818,704 (Laitram Corp) discloses apparatus for converting the energy of surface waves in a liquid such as the ocean. It comprises a buoyant helical member mounted for rotation about an axis.

### SUMMARY OF THE INVENTION

Accordingly, the present invention is directed to a wave-power device comprising a rotatable elongate part comprising axle and a buoyant structure helically coiled around the axle and extending at least part of the length thereof, the rotatable elongate part being connected to a power generator, characterized in that the buoyant structure has a cross-sectional shape having a width greater than its height.

Preferably, the buoyant structure comprises a cross-section that is asymmetric. By having an asymmetrical cross-section the buoyant structure is able to pass through the water more smoothly, thereby decreasing its resistance and increasing the efficiency of the device.

Advantageously, the cross-sectional shape of the buoyant structure comprises a substantially convex lead edge. The convex lead edge reduces the resistance experienced by the device as it passes through the water.

It is preferable that the cross-sectional shape of the buoyant structure comprises a substantially flat or substantially concave tail edge. The flat or concave tail edge provides a relatively large surface for the waves to contact, thereby increasing the force harnessed by the device during operation. A concave shape allows the device to ‘catch’ the water and can therefore use the mass of the water to aid with rotation about the axle.

It is advantageous that the buoyant structure comprises a fin extending in a direction substantially perpendicularly to the axle. The fin increases the efficiency of the device by harnessing the power present in the trough of the waves. The cyclical force of the water at each trough in the waves is in a direction opposite to that at the crest of the waves. The fin provides a surface against which the force at the trough can act to provide increased rotation of the device.

It is preferable that a float member is provided on the buoyant structure. The float member may be provided on the surface of the structure and/or at the front end thereof. It may be in the form of a flat, float strip attached to the structure or a buoy at the end of the helical structure that first contacts the waves. The float member may be aligned with the lead edge of the buoyant structure. The float member is used to cock the rotatable part in a position such that it is ready to rotate upon the on-coming wave reaching the device. The float puts the rotatable member in its intended ‘ready’ position so that when the wave front reaches the rotatable member, it is orientated to be rotated by the wave. This increases the efficiency of the device, rather than it having to orientate itself whilst the wave passes over.

In one embodiment, the buoyant structure is a continuous structure along the length of the axle. By forming a continuous structure, the device is most efficient as the water cannot pass through the buoyant structure without exerting a force to rotate it.

In an alternative embodiment, the buoyant structure comprises a plurality of discrete bodies along the length of the axle. In such a construction should a part of the buoyant structure become damaged, it can be removed and replaced without the need to replace the whole length of the device.

In a preferred construction, both ends of the device are moored to retain the axle in a substantially stable position with respect to the wave direction. By holding the device at a predetermined angle, or within a predetermined range, the device can be positioned such that it is at its most efficient. Additionally, the risk of the device hitting vessels and wildlife is reduced as it is held securely.

It is advantageous that the mooring is a dynamic mooring to keep the axle substantially at a predetermined angle with respect to the wave direction. The mooring can be provided with means for maintaining the position of the device and adjusting the angle of the device with respect to the direction of the wave front automatically. This may be by way of motors or by automatic adjustment of the mooring lines to change the orientation and/or position of the device. Real-time data may be used along with the device being provided with a GPS system in order to dynamically adjust its position. The elongate member comprises a plurality of GPS locating devices, with at least one at each end and a processing device to determine its position. Additionally, the processor is provided with information on the direction of the wave front. The processor uses the information provided to detect the alignment of the device with respect to the wave front and adjusts the mooring to ensure that the device is aligned correctly. As an example, it may be desirable to retain the device at an angle of between 50 degrees and 75 degrees with respect to the direction of the wave front. Alternatively, the device may be supplied with weather forecast information and adapt its position accordingly.

Preferably, the axle is connected to a neutrally buoyant power generator, and in that the power generator is substantially submerged beneath the water. In such an arrangement, the generator remains still whilst the device passes through the waves. The axle of the device may be attached to the power generator by way of a right-angled connection member.

It is advantageous that the device comprises a first rotatable elongate part and a second rotatable elongate part with both rotatable elongate parts being connected to a single power generator, and in that the two rotatable elongate parts are arranged to be contrarotating. In such a construction, the first buoyant structure of the two elongate parts may comprise a left-handed helical construction, and the second buoyant structure comprises a right-handed helical construction. The elongate parts may be integrally connected to the generator. Using contra-rotating devices provides the advantage of doubling the effective rotation speed to allow direct drive generators.

The invention extends to a method of mooring a wave-power device.

### BRIEF DESCRIPTION OF THE DRAWINGS

An embodiment of the invention will now be described, by way of example only, and with reference to the accompanying drawings, in which:

FIG. 1 is a diagram showing perspective view of a device according to the present invention;

FIGS. 2A to 2D show cross-sectional profiles for embodiments of a device according to the present invention;

FIG. 3 is a close-up view of the device shown in FIG. 1 showing an orientation float;

FIG. 4 is a diagram showing another embodiment of the present invention in situ;

FIG. 5 is a top view of the device shown in FIG. 1 showing the mooring;

FIG. 6 is a close-up view of one end of the device shown in FIG. 5;

FIG. 7 is a further embodiment of a device according to the present invention; and

FIG. 8 is another embodiment of a device according to the present invention.

### DETAILED DESCRIPTION OF EXEMPLARY EMBODIMENTS

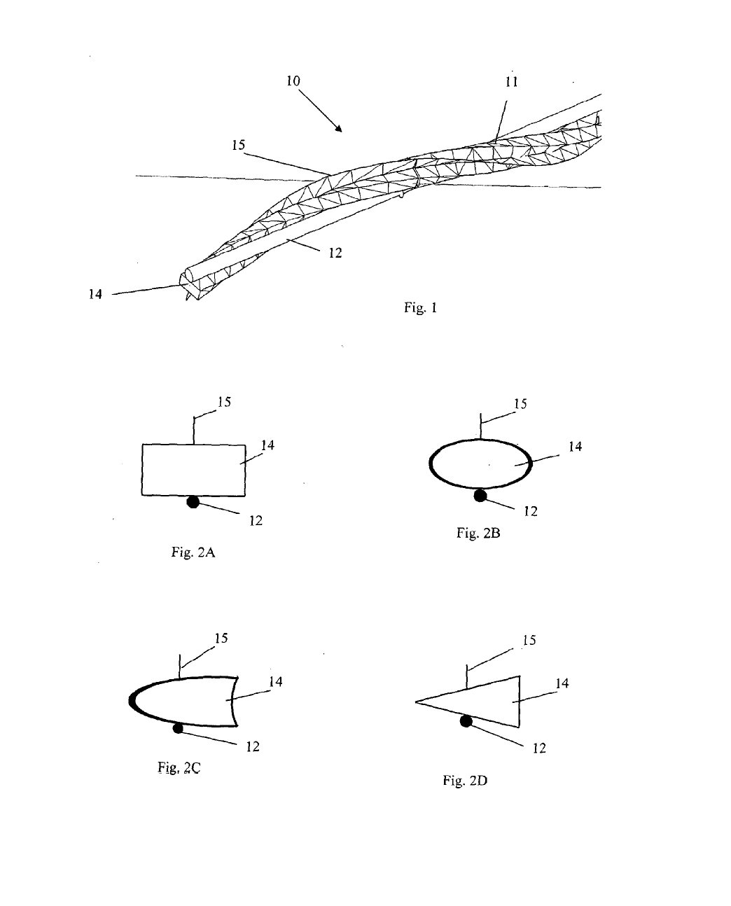

FIG. 1 shows a wave-power device 10 for generating electricity from the motion of the waves. The device 10 comprises a rotatable elongate part 11, which comprises an axle 12 and a buoyant structure 14 attached thereto, the buoyant structure 14 comprising a helical part extending the length of the axle. The pitch of the helical structure 14 may be such that in a 60 meter length of axle 12, there is a single rotation, or lead, of the structure 14. The buoyant structure 14 has a fin 15 positioned on the surface furthest from the axle 12 and extending in a direction substantially perpendicular from the axle 12.

FIGS. 2A to 2D show different possible cross-sectional shapes for the buoyant structure 14. In each of the FIGS. 2A to 2D, the width of the cross-section of the buoyant structure 14 is longer than the height of the structure 14. The cross-section may be, as shown in the Figures, rectangular (2A), elliptical (2B), ‘bullet-shaped’ (2C), triangular (2D) or it may comprise a further shape (not shown), for example an oval. The bullet-shaped cross-section 2C comprises a convex lead edge and a concave trail edge in order to pass through the water as efficiently as possible. The tail edge of the triangular cross-section (2D) may be tapered at the trailing edge to aid with reduced resistance through the water. The buoyant structure 14 is substantially rigidly connected to the axle 12.

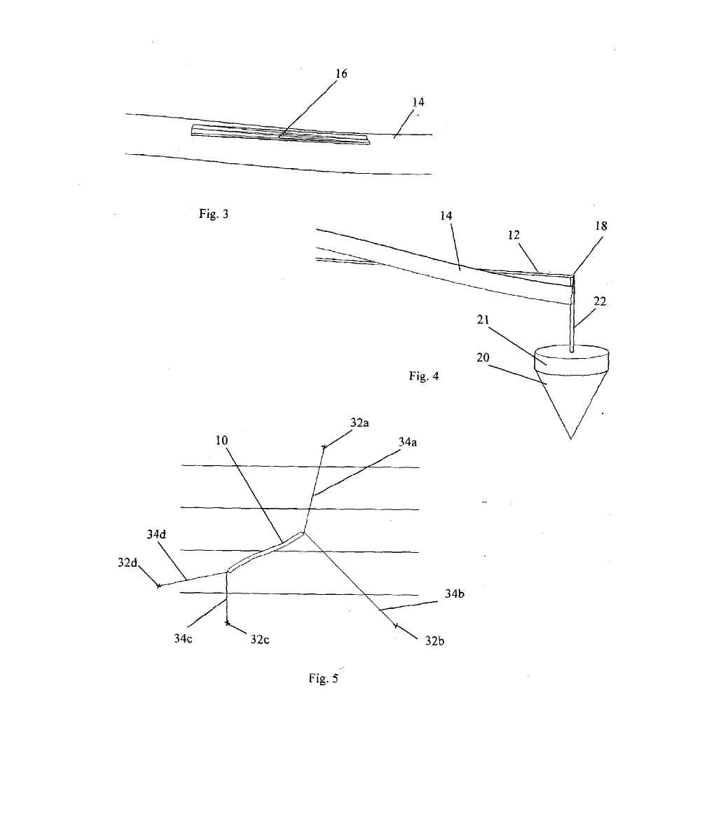

In order to ensure that the device is in a ‘cocked’ position, such that it is ready to rotate upon a wave passing along the device 10, a buoyant strip, or float, 16 is attached to a part of the buoyant structure 14, as shown in FIG. 3. The strip 16 comprises a material that is particularly buoyant in water and, because the strip 16 is attached to the buoyant structure 14, in a natural resting state of the device 10, the buoyant structure 14 will rest in a position wherein the strip 16 is on an upper surface. The strip 16 is located in a position that would be in an upward position when the device is ready to be operated.

The lead end 18 of the axle 12—that is the end facing the oncoming waves—is connected to a power generator 20 via a connection member 22. The connection member 22 comprises a right angle joint to allow the power generator 20 to be submerged. By being neutrally buoyant and submerged, the power-generator 20 is kept substantially stationary and does not affect the movement of the waves onto the device rotatable part 11. A flywheel 21 may be provided between the axle 12 and the power generator 20 to store the rotational energy provided by the rotatable part 11. Additionally, a gearbox (not shown) may be provided to control the torque supplied to the power generator 20.

As a wave passes along the device 10, which is partially submerged in the water, the buoyant helical structure 14 rotates according to the location of the crest of the wave. This rotates the axle 14, which in turn, being connected to a power generator 20, rotates the gearing within the generator 20 to produce power.

When in use, due to the positioning of the device 10, the waves travel at an angle along the length of the rotatable part 11. As the waves pass along the length, the helical buoyant structure 14 rotates to allow the part of the buoyant structure 14 that is in contact with the crest of the wave to be uppermost. Due to the helicoid nature of the buoyant structure 14, the rotatable part 11 turns one 360 degree rotation as the way passes down one lead of the structure 14. In order to ensure that the device is correctly orientated such that the lead end 18 of the buoyant structure 14 engages the oncoming wave correctly, buoyancy strip 16 floats upwardly when the wavelength is less that the length of the buoyant helical structure 14, for example in flat waters. This allows the device 10 to be positioned in a rest position when the wave frequency is low or when the wavelength is too long to provide continuous operation of the device 10. The buoyancy of the strip 16 can be overcome by rotation of the buoyant structure 14 about the axle 12 when exposed to the wave front, so that the rotatable part 11 rotates and provides a driving force to the power generator 18.

In use, the device 10 rotates upon one wave and waits for the next wave. It does not require a continuous wave front in order to operate and will not stall if there is a significant change in the wavelength of the waves.

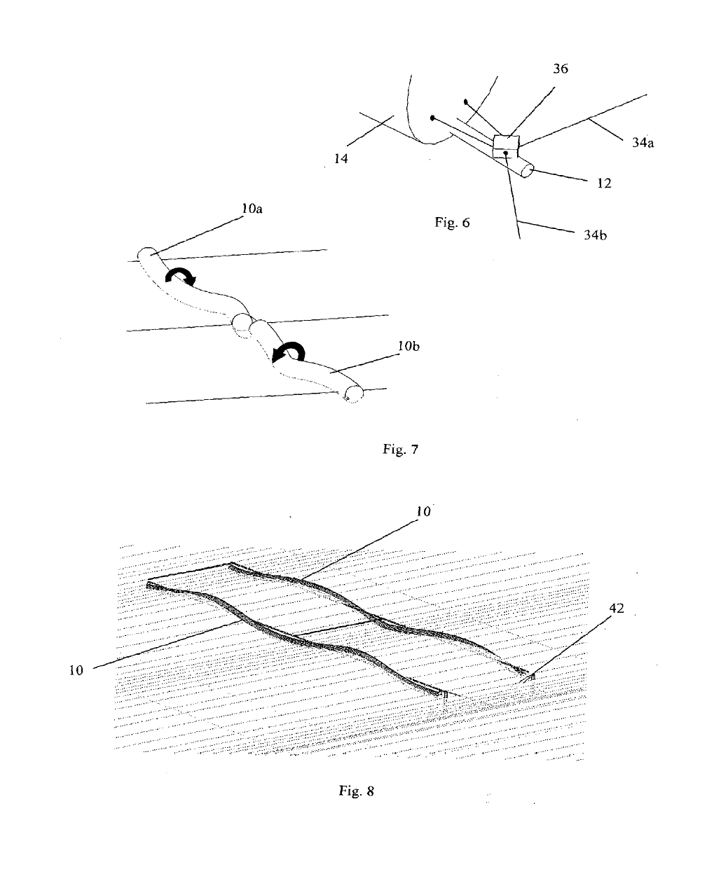

FIGS. 5 and 6 show a device 10 held in position by a series of moorings 32a to 32d, each having a first end secured to the seabed and a second end connected to the device 10 by way of a series of cables 34a to 34d. These cables 34 pass into the device and are engaged by a gripping mechanism (not shown), which comprises a pulley (not shown). The cables are connected to a slip-link device (not shown) to prevent them from becoming twisted when the device 10 rotates. As shown in more detail in FIG. 6, the cables 34 pass through a block 36 just prior to entering the device 10. The gripping mechanism comprises a motor that runs along the cables 14 in order to adjust the position of the device 10 with respect to the moorings 32.

FIG. 7 shows an arrangement of two devices 10a and 10b, both connected to a generator (not shown) at the ends closest one another. As shown by the arrows, the devices 10a and 10b are of a construction that allows for them to be contra-rotating. Such an arrangement allows for two sources of torque for the power generator and increases the power harnessed from a single wave front. Additionally, the devices 10a and 10b can be sized such that the wavelength of the waves will allow an almost continuous operation of the power generator.

FIG. 8 shows a two a pair of devices 10, arranged to be contra-rotating and connected to a framework 42. The device uses a processing unit (not shown) to capture CO2 and create alkanes, which are then stored in a neutrally buoyant storage tank (not shown) attached to the framework 42 and below the water's surface for the storage of generated fuel. The device is controlled using a GPS system and a series of vanes, turbines and/or motors attached to the storage tank. A processor takes GPS readings to ensure that the system is retained in a substantially stationary position. The estimate power output of such a device is several hundred mega-Watts per hour.

The device may comprise steel, marine concrete and/or plastics material.

The device may comprise a GPS system in order to dynamically adjust its position. The position may be adjusted in response to a change in the direction of the waves. The adjustment of the position may be undertaken by way of paddles extending from the device and may be powered by electricity, hydrogen, or other fuel.

The device may be provided with a gear box positioned between the rotatable elongate part and the power generator to control the torque delivered to the power generator. The power generator may be integral with the rotatable structure or embedded therein. This allows for less motion and direct drive of the power generator. Additionally, a more simple design with fewer moving parts may be created.

Whilst the device has been shown in the drawings as having the buoyant structure attached tangentially to the axle, the buoyant structure is shaped to be attached to the axle. Alternatively, or additionally, the axle may pass through the buoyant structure such that it is included within the boundary of the edge of the buoyant structure. The, or each, rotatable elongate part may comprise vanes about its circumference, the vanes providing a force to assist with orientating the device with respect to the wave front direction. The vanes may be offset to a predetermined angle, for example, 60 degrees so that the device is orientated at that angle to the waves. The angle of the vanes may be adjustable, and could be remotely adjustable in order to adjust the angle of orientation with respect to the wave direction.

The pitch of the helical buoyant structure may be set to 1.5 times the average wavelength.

The pitch may be adjustable by stretching or contracting the buoyant structure, or it may be telescopic so that the pitch can be altered.

The device does not require any housing and can be positioned and connected to moorings before being left to operate.

Large seas may pass over the device unimpeded.

The device may be constructed by rolling steel piles to deform them to the appropriate helical shape. Alternatively, they may be constructed from joining short straight sections of pipe to make a helical structure.

A plurality of devices may be arranged to all connect to a central position. For example, four devices may form a cross-shape with a central power generator, or plurality of central power generators in the middle of the cross-shape.

1. A wave-power device comprising a rotatable elongate part comprising axle and a buoyant structure helically coiled around the axle and extending at least part of the length thereof, the rotatable elongate part being connected to a power generator, characterised in that the buoyant structure has a cross-sectional shape having a width greater than its height.

2. A wave-power device according to claim 1, characterised in that the buoyant structure comprises a cross-section that is asymmetric.

3. A wave-power device according to claim 1, characterised in that the cross-sectional shape of the buoyant structure comprises a substantially convex lead edge.

4. A wave-power device according to claim 1, characterised in that the cross-sectional shape of the buoyant structure comprises a substantially flat or substantially concave tail edge.

5. A wave-power device according to claim 1, characterised in that the buoyant structure comprises a fin extending in a direction substantially perpendicularly to the axle.

6. A wave-power device according to claim 1, characterised in that a float member is provided on the buoyant structure.

7. A wave-power device according to claim 1, characterised in that the buoyant structure is a continuous structure along the length of the axle.

8. A wave-power device according to claim 1, characterised in that the buoyant structure comprises a plurality of discrete bodies along the length of the axle.

9. A wave-power device according to claim 1, characterised in that both ends of the device are moored to retain the axle in a substantially stable position with respect to the wave direction.

10. A wave-power device according to claim 9, characterised in that the mooring is a dynamic mooring to keep the axle substantially at a predetermined angle with respect to the wave direction.

11. A wave-power device according to claim 10, characterised in that the axle is connected to a neutrally buoyant power generator, and in that the power generator is substantially submerged beneath the water.

12. A wave-power device according to claim 1, characterised in that the device comprises a first rotatable elongate part and a second rotatable elongate part with both rotatable elongate parts being connected to a single power generator, and in that the two rotatable elongate parts are arranged to be contra-rotating.
